(19) United States
(12) Patent Application Publication
(10) Pub. No.: US 2016/0214481 A1
(43) Pub. Date: Jul. 28, 2016

(54) CONTENT CUSTOMIZATION AND PRESENTATION

(71) Applicant: CLOUDCAR, INC., Mountain View, CA (US)

(72) Inventor: Konstantin Othmer, Los Altos, CA (US)

(21) Appl. No.: 14/982,785

(22) Filed: Dec. 29, 2015

Related U.S. Application Data
(60) Provisional application No. 62/108,370, filed on Jan. 27, 2015.

(51) Int. Cl. B60K 35/00; G10L 13/04

(52) U.S. Cl. CPC B60K 35/00; G10L 13/043; B60K 2350/35; B60K 2350/1056; B60K 2350/1096

(57) ABSTRACT

A method of providing content for presentation in a vehicle may include creating personalized content for a user based on one or more customization factors. The method may additionally include determining a virtual presenter personality configured to customize a presentation of the personalized content. The method may additionally include creating audio data that incorporates the personalized content based on the virtual presenter personality. The method may additionally include providing the audio data configured to be presented in the vehicle.

### CROSS-REFERENCE TO RELATED APPLICATIONS

This application claims the benefit of and priority to U.S. Provisional Patent Application Ser. No. 62/108,370, filed Jan. 27, 2015, which is incorporated herein by reference in its entirety.

### FIELD

Some embodiments described herein generally relate to customizing and presenting content in a vehicle.

### BACKGROUND

Unless otherwise indicated herein, the materials described herein are not prior art to the claims in the present application and are not admitted to be prior art by inclusion in this section.

Content consumption in a vehicle may be different from consuming content on a smartphone, a tablet, or another suitable client device. For example, a user that operates a tablet may view content using a web browser or an application installed on the tablet. The user may perform one or more gestures on a touch screen of the tablet to interact with the content. However, if the user drives a vehicle, it is preferable that the consumption of content in the vehicle not distract the user from the driving task. For example, the user may like the content to be presented in an audio form so that the user may keep his or her eyes on the road while consuming the content. Alternatively or additionally, the user may like to interact with the content even if he or she keeps his or her hands on the steering wheel of the vehicle.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY OF SOME EXAMPLE EMBODIMENTS

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter.

Some example embodiments described herein generally relate to content customization and presentation in a vehicle.

In an example embodiment, a method of providing content for presentation in a vehicle is described. The method may include creating personalized content for a user based on one or more customization factors. The method may additionally include determining a virtual presenter personality configured to customize a presentation of the personalized content. The method may additionally include creating audio data that incorporates the personalized content based on the virtual presenter personality. The method may additionally include providing the audio data configured to be presented in the vehicle.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 is a block diagram of an example operating environment configured to provide content for presentation in a vehicle;

FIG. 2 shows an example flow diagram of a method of providing content for presentation in a vehicle;

FIG. 3 shows an example flow diagram of a method of customizing content for a user; and

FIG. 4 is a block diagram that illustrates an example computing device that is arranged for customizing and/or presenting content in a vehicle.

### DETAILED DESCRIPTION OF SOME EXAMPLE EMBODIMENTS

Embodiments described herein generally relate to content customization and presentation.

Some embodiments described herein may allow proactively personalizing and presenting content in a vehicle. The content configured to be presented to a user may be customized based on a user preference (e.g., an explicit or implicit user preference), a user profile, a content interaction history associated with the user, a driving context associated with a current journey taken by the user, and/or other customization factors. For example, the content may be personalized for the user based on one or more user interests, likes and/or dislikes, user demographic data, a destination, a weather condition, a traffic condition, a driving scene (e.g., urban, suburban, forest, or another driving scene), content ratings, and/or any other customization factors.

In some embodiments, the personalized content may be presented using a virtual presenter. The virtual presenter may include a virtual person programmed to converse with the user. For example, the virtual presenter may include a virtual radio disc jockey (DJ) that may deliver the personalized content to the user using a machine-synthesized speech. The personalized content may be wrapped in an articulation of the virtual radio DJ configured to deliver the machine-synthesized speech. A voice of the virtual presenter may be obtained from an interactive voice response (IVR) voice, pre-programmed human voices, and/or any other synthetic voices. The virtual presenter may provide commentary, respond to user comments, offer suggestions, and/or provide driving directions to the user in real time.

In some embodiments, a personality of the virtual presenter (also referred to as a virtual presenter personality) may be determined or programmed based on a content type of the personalized content, a personality of the user, a user profile, a user preference, a real-time driving context (e.g., a destination, a route, a time of day, a driving scene, weather, traffic conditions, and/or any other context data), and/or any other factors. Alternatively or additionally, the virtual presenter personality may be programmed based on one or more inputs from the user. The virtual presenter may be configured to verbally deliver the personalized content to the user in a manner that matches the virtual presenter personality.

Audio data that incorporates the personalized content may be created based on the virtual presenter personality. For example, an audio recording may be synthesized in which the virtual presenter may verbally present the personalized content using a synthetic voice and tone that match the virtual presenter personality. The personalized content may be presented in the vehicle by playing the audio data in the vehicle. For example, assume that the personalized content includes a song from an artist. The audio data may include (1) a machine-synthesized speech in which the virtual presenter is programmed to verbally introduce the song using a synthetic voice and (2) an audio track of the song. The audio data may be presented to the user by playing the machine-synthesized speech first and then the audio track of the song using a speaker system.

In some embodiments, the personalized content may be created and presented to the user in a proactive manner rather than a reactive manner. Responsive to detecting that the user is on board in the vehicle, content may be personalized and presented in the vehicle on-the-fly with no requirement of user interaction. The user may consume the personalized content passively. In some embodiments, a third-party content provider may provide the personalized content and/or the audio data for presentation in the vehicle. The third-party content provider may determine or configure the personality of the virtual presenter to customize a presentation of the personalized content.

Additionally, the user may interact with the personalized content. For example, the user may provide a verbal input as if the user converses with the virtual presenter that verbally delivers the personalized content to the user. A microphone mounted or otherwise present in the vehicle may capture the user's verbal input. The personalized content may then be updated based on the user's verbal input. In some embodiments, one or more actions may be performed responsive to the user's verbal input. For example, a restaurant may be set as a new destination for a navigation application responsive to a user's verbal input “Go to the restaurant you just recommended.” In another example, a transaction may take place responsive to a user's verbal input “Buy me the gift set from the store you just talked about.”

Reference will now be made to the drawings to describe various aspects of some example embodiments of the invention. The drawings are diagrammatic and schematic representations of such example embodiments, and are not limiting of the present invention, nor are they necessarily drawn to scale.

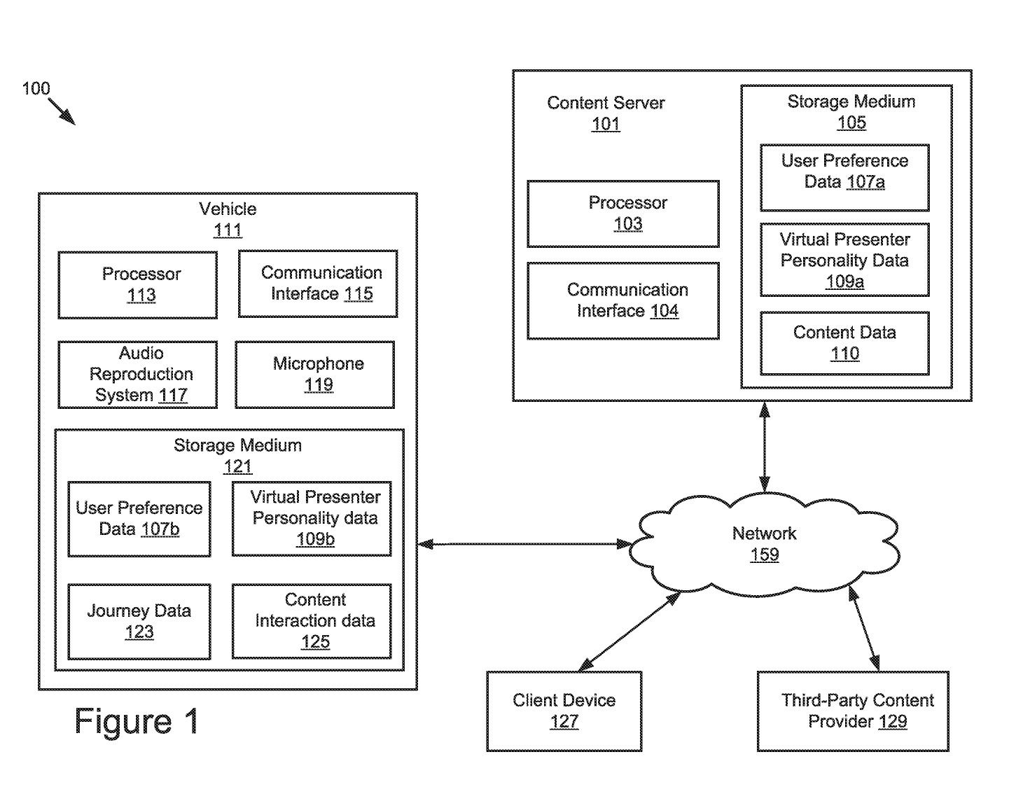

FIG. 1 is a block diagram of an example operating environment 100 that includes a content server 101, a vehicle 111, a client device 127, and a third-party content provider 129, arranged in accordance with at least some embodiments described herein. The vehicle 111, the content server 101, the client device 127, and the third-party content provider 129 may cooperate with each other to customize content for presentation in the vehicle 111. Although one vehicle 111, one content server 101, one client device 127, and one third-party content provider 129 are illustrated in FIG. 1, more generally the operating environment 100 may include one or more vehicles 111, one or more content servers 101, one or more client devices 127, and one or more third-party content providers 129. In these and other embodiments, the operating environment 100 may include other servers and/or devices not shown in FIG. 1, such as a map server for providing a map service to the vehicle 111, a traffic server for aggregating and providing traffic information, and/or a weather server for providing weather information.

The operating environment 100 may additionally include a network 159. In general, the network 159 may include one or more wide area networks (WANs) and/or local area networks (LANs) that enable the vehicle 111, the content server 101, the client device 127, and the third-party content provider 129 to communicate with each other. In some embodiments, the network 159 may include the Internet, including a global internetwork formed by logical and physical connections between multiple WANs and/or LANs. Alternately or additionally, the network 159 may include one or more cellular radio frequency (RF) networks and/or one or more wired and/or wireless networks such as, but not limited to, 802.xx networks, Bluetooth access points, wireless access points, Internet Protocol (IP)-based networks, or the like. For example, the network 159 may include a mobile data network such as third-generation (3G), fourth-generation (4G), long-term evolution (LTE), Voice-over-LTE (VoLTE), or any other mobile data network or combination of mobile data networks. In some embodiments, the network 159 may include a global positioning system (GPS) satellite for providing GPS navigation to the vehicle 111. The network 159 may also include servers that enable one type of network to interface with another type of network.

The content server 101 may include a hardware server that may include a processor 103, a storage medium 105, and a communication interface 104. The processor 103 may be of any type including, but not limited to, a central processing unit (CPU), a microprocessor (μP), a microcontroller (μc), a digital signal processor (DSP), or any combination thereof. The processor 103 may be configured to execute computer instructions that, when executed, cause the processor 103 to perform or control performance of one or more of the operations described herein with respect to the content server 101.

The storage medium 105 may include volatile memory such as random access memory (RAM), persistent or non-volatile storage including, but not limited to, read only memory (ROM), electrically erasable and programmable ROM (EEPROM), compact disc-ROM (CD-ROM) or other optical disk storage, magnetic disk storage or other magnetic storage device, NAND flash memory or other solid state storage device, or other persistent or non-volatile computer storage medium. Accordingly, the storage medium 105 may include a non-transitory computer-readable medium. The storage medium 105 may store computer instructions that may be executed by the processor 103 to perform or control performance of one or more of the operations described herein with respect to the content server 101.

The storage medium 105 may additionally store user preference data 107a , virtual presenter personality data 109a, and content data 110. The user preference data 107a may include data that describes user preferences associated with different users. In some embodiments, a user preference associated with a user may indicate what the user likes and/or dislikes.

The virtual presenter personality data 109a may include data that describes one or more virtual presenters and how the one or more virtual presenters may speak and act. A virtual presenter may include a virtual radio DJ, a virtual celebrity, a virtual television (TV) announcer, a virtual TV show host, a virtual story teller, or any other virtual character that may be programmed to talk to a user. A voice of the virtual presenter may be obtained from an IVR voice, pre-programmed human voices, and/or any other synthetic voices. A voice and/or a manner in which the virtual presenter speaks may be determined based on a personality configured for the virtual presenter. For example, a virtual story teller that tells stories to a kid on board in the vehicle 111 may be configured to speak clearly and slowly while a virtual football narrator may be configured to speak in a fast pace and shout out from time to time. A speech of the virtual presenter may be synthesized by the content server 101, the third-party content provider 129, and/or a speech synthesizer installed in the vehicle 111. The speech may cover the personalized content intended to deliver to the user.

The content data 110 may include data that describes different types of content. The content may include music, movie, news, audio books, podcasts, advertisements (ads), sports games, concert recordings, meeting recordings, promotions and deals, and any other types of content. In some embodiments, the content may include text content, audio content, and/or visual content.

More generally, the storage medium 105 may store any other data for providing the functionality described herein. For example, the storage medium 105 may store user profile data that describes user profiles of different users. A user profile associated with a user may include a user name, an email address, education background, working experience, a home address, a work address, interests, hobbies, an occupation, demographic data, and any other user data associated with the user. In another example, the storage medium 105 may store content interaction data that describes how users on board in different vehicles 111 have interacted with personalized content presented in the vehicles 111.

The communication interface 104 may provide any suitable form of communication capability between the content server 101 and one or more of the vehicle 111, the client device 127, the third-party content provider 129, and the network 159. For example, the communication interface 104 may include a network interface controller for connecting the content server 101 to the network 159 via wired connection mechanisms or wireless mechanisms. In some embodiments, the communication interface 104 may include a wireless-fidelity (Wi-Fi) card for providing Wi-Fi connectivity. By way of example and not limitation, the communication interface 104 may be configured to provide, via wireless mechanisms, LAN connectivity, Bluetooth connectivity, Wi-Fi connectivity, near field communication (NFC) connectivity, Machine-to-Machine (M2M) connectivity, Device-to-Device (D2D) connectivity, cellular network connectivity, any other suitable communication capability, or any suitable combination thereof. In some embodiments, the communication interface 104 may include a transmitter and/or a receiver for providing any suitable form of communication capability described herein.

In general, the vehicle 111 may include an automobile or any other type of vehicle. The vehicle 111 may include a computing device that includes a processor 113, a communication interface 115, an audio reproduction system 117, a microphone 119, and a storage medium 121. More generally, the vehicle 111 may include other components not shown in FIG. 1 (e.g., a touch screen for displaying visual content, buttons such as steering wheel buttons for providing user inputs).

The audio reproduction system 117 may include any device configured to reproduce an audio sound from an input signal. For example, the audio reproduction system 117 may include a speaker system, a pair of headphones, a headset, and/or any other type of audio reproduction devices. The microphone 119 may be configured to capture user voice inputs in the vehicle 111.

Similar to the processor 103 of the content server 101, the processor 113 may be of any type including, but not limited to, a CPU, a μP, a μC, a DSP, or any combination thereof. The processor 113 may be configured to execute computer instructions that, when executed, cause the processor 113 to perform or control performance of one or more of the operations described herein with respect to the vehicle 111.

Similar to the storage medium 105 of the content server 101, the storage medium 121 may include volatile memory such as RAM, persistent or non-volatile storage including, but not limited to, ROM, EEPROM, CD-ROM or other optical disk storage, magnetic disk storage or other magnetic storage device, NAND flash memory or other solid state storage device, or other persistent or non-volatile computer storage medium. Accordingly, the storage medium 121 may include a non-transitory computer-readable medium. The storage medium 121 may store computer instructions that may be executed by the processor 113 to perform one or more of the operations described herein with respect to the vehicle 111.

In some embodiments, the storage medium 121 may store user preference data 107b , virtual presenter personality data 109b , journey data 123, and content interaction data 125. More generally, the storage medium 121 may store any other data for providing the functionality described herein. For example, the storage medium 121 may store a user profile associated with a user on board in the vehicle 111.

The user preference data 107b may include data that describes one or more user preferences associated with one or more users on board in the vehicle 111. The user preference data 107b may be uploaded to the content server 101 and may be stored as part of the user preference data 107a.

The virtual presenter personality data 109b may include data that describes one or more virtual presenters configured for the vehicle 111 and/or configured for one or more corresponding drivers and/or passengers of the vehicle 111, and/or data that describes how the one or more virtual presenters may be programmed to speak and act. In some embodiments, the virtual presenter personality data 109b may include one or more default virtual presenters configured for the vehicle 111 based on a user preference.

The journey data 123 may include data that describes one or more journeys associated with the vehicle 111. For example, the journey data 123 may include a start point, a destination, a route, a time of departure, a time of arrival, a travel distance, a duration, and any other data related to a historical journey, a current journey, and/or a future journey taken by the vehicle 111. In some embodiments, the journey data 123 may include data that describes a driving context related to a journey. For example, the driving context may include a destination that the vehicle 111 travels to, a route to the destination, weather conditions along the route, traffic conditions along the route, points of interest along the route, driving scenes along the route, one or more users on board in the vehicle 111 (e.g., a driver and one or more passengers), and any other context data related to the driving of the vehicle 111. Example driving scenes may include a forest scene, a suburban scene, an urban scene, a mountain scene, a coast scene, and any other suitable driving scene. In these and other embodiments, the journey data 123 may include any other data related to the driving of the vehicle 111.

The content interaction data 125 may include data that describes how a user on board in the vehicle 111 interacts with content presented in the vehicle 111. For example, the user may press a button on a steering wheel and/or provide a verbal input to answer a question asked by a virtual presenter. In some embodiments, the content interaction data 125 may include data that describes a content interaction history associated with the user.

The communication interface 115 may provide any suitable form of communication capability between the vehicle 111 and one or more of the content server 101, the client device 127, the third-party content provider 129, and the network 159. The communication interface 115 may provide wired and/or wireless communication capability. For example, the communication interface 115 may include a Wi-Fi card for providing Wi-Fi connectivity. By way of example and not limitation, the communication interface 115 may be configured to provide, via wireless mechanisms, LAN connectivity, Bluetooth connectivity, Wi-Fi connectivity, NFC connectivity, M2M connectivity, D2D connectivity, cellular network connectivity, any other suitable communication capability, or any suitable combination thereof. In some embodiments, the communication interface 115 may include a transmitter and/or a receiver for providing any suitable form of communication capability described herein.

The client device 127 may include a computing device that includes a memory and a processor, for example, a laptop computer, a desktop computer, a tablet computer, a mobile telephone, a personal digital assistant (PDA), a mobile e-mail device, a portable game player, a portable music player, a wearable device, a television with one or more processors embedded therein or coupled thereto, or another electronic device capable of accessing the network 159. In some embodiments, a user may use the client device 127 to configure one or more user preferences and/or one or more default virtual presenters.

The third-party content provider 129 may include an entity that may provide content to the vehicle 111 and/or the content server 101. For example, the third-party content provider 129 may provide personalized content to the vehicle 111 so that the personalized content may be presented in the vehicle 111. The third-party content provider 129 may also determine a virtual presenter personality for presenting the personalized content. In another example, different third-party content providers 129 may provide different pieces of content to the vehicle 111 and/or the content server 101. The vehicle 111 and/or the content server 101 may score the different pieces of content and may present a piece of content with a highest score as personalized content in the vehicle 111. The third-party content provider 129 may include a processor, a memory, and network communication capabilities for providing the functionality described herein.

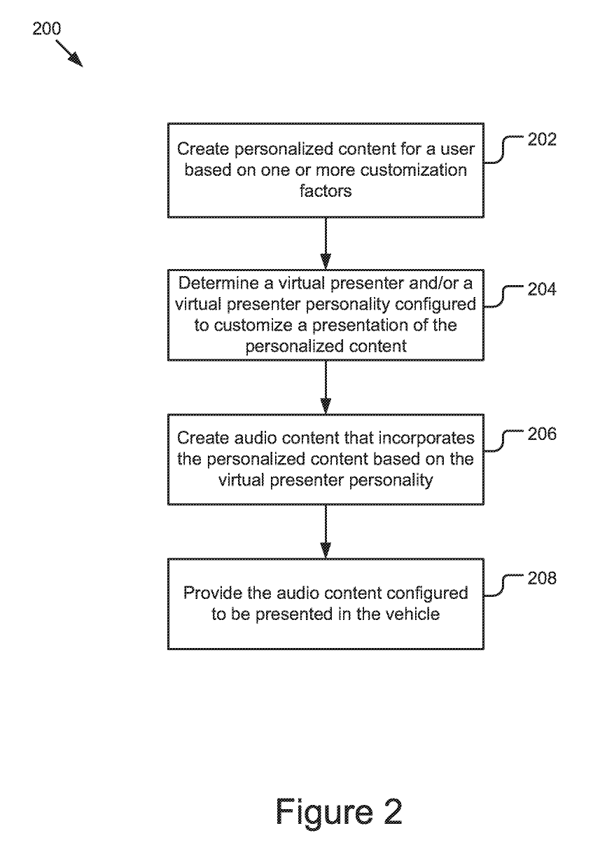

FIG. 2 shows an example flow diagram of a method 200 of providing content for presentation in the vehicle 111, arranged in accordance with at least some embodiments described herein. The method 200 may be performed in whole or in part by, e.g., the content server 101, the vehicle 111, and/or the third-party content provider 129 of FIG. 1. Although illustrated as discrete blocks, various blocks may be divided into additional blocks, combined into fewer blocks, or eliminated, depending on the desired implementation.

The method 200 may begin at block 202 in which personalized content may be created for a user based on one or more customization factors. The user may be on board in the vehicle 111 and the personalized content may be created proactively. The one or more customization factors may include a user preference, a user profile, a content interaction history associated with the user, a driving context associated with a current journey taken by the user, and/or any other factors used to customize content.

In some embodiments, the method 200 may include receiving content from the content server 101, the third-party content provider 127, and/or any other content providers. The method 200 may include customizing the received content to generate personalized content for the user based on one or more user preferences and/or a user profile associated with the user. For example, the method 200 may select one or more pieces of content that match the user's interests from the received content as personalized content for the user.

Alternatively or additionally, the method 200 may include customizing the received content based on a content interaction history associated with the user. For example, the content interaction history may indicate that the user usually provides an input if music from a particular artist is played to the user (e.g., the user may comment on the music verbally or press a button on a steering wheel to endorse the music). The method 200 may select an ad related to a concert of the artist from the received content as personalized content for the user.

Alternatively or additionally, the method 200 may include customizing the received content based on a driving context associated with a journey taken by the vehicle 111. The driving context may include a real-time driving context of the current journey taken by the vehicle 111. For example, if a driving scene indicates that the vehicle 111 currently travels on a mountainous area, the method 200 may select country music from the received content as personalized content for the user. In another example, if a current weather condition is cold and cloudy, the method 200 may select a song performed by an artist with a warm and pleasant voice as personalized content for the user. In yet another example, if an estimated duration for the journey lasts for more than two hours, the method 200 may select an audio book as personalized content for the user so that the user may enjoy the book during the journey. However, if the estimated duration is estimated to last for a relatively short time, such as only ten minutes, the method 200 may select one or two songs and/or one or two pieces of news as personalized content for the user.

At block 204, a virtual presenter and/or a virtual presenter personality may be determined. The virtual presenter may be programmed to speak and act according to the virtual presenter personality. For example, the virtual presenter may be programmed to talk in a manner according to the virtual presenter personality. The virtual presenter personality may be configured to customize a presentation of the personalized content. In some embodiments, the virtual presenter personality may be determined based on one or more default settings configured for the user. Alternatively or additionally, the virtual presenter personality may be determined based on a content type of a content item in the personalized content. For example, if the personalized content includes a story for kids, the method 200 may select a virtual story teller personality so that the story may be presented as told by a virtual story teller.

Alternatively or additionally, the virtual presenter personality may be determined based on a personality of the user, a user profile (e.g., demographic data), a content interaction history, a video viewing history, and/or a user preference (e.g., a personality that the user likes). For example, if the user is a humorous person, a virtual comedian personality may be selected so that the personalized content may be presented in a manner that matches characteristics of a comedian. In another example, if the content interaction history indicates that the user usually provides an input to content presented by a particular virtual presenter, the particular virtual presenter may be selected for presenting the personalized content. In yet another example, if the video viewing history of the user indicates that the user has watched a talk show presided by a particular host, a virtual presenter that talks and acts in a manner similar to the particular host may be selected for presenting the personalized content.

Alternatively or additionally, the virtual presenter personality may be determined based on a driving context associated with the journey such as a driving scene, a traffic condition, a weather condition, and/or any other context data. For example, if a current driving scene indicates that the user currently drives through a national forest, a fictional character that lives in a forest from a movie may be selected for presenting the personalized content. In another example, if the user drives on a congested highway in a gloomy day, a virtual presenter that speaks with a happy voice and relaxed tones may be selected for presenting the personalized content. Accordingly, the virtual presenter and/or virtual presenter personality may be selected to match a user preference, driving context, or the like, or to be the opposite of or complement to a user preference, driving context, or the like.

At block 206, audio data that incorporates the personalized content may be created based on the virtual presenter personality. For example, the method 200 may include synthesizing a speech in which the virtual presenter talks about the personalized content according to a manner of the virtual presenter personality. In another example, the personalized content may include a story for kids. An audio file that records the story told by a virtual story teller may be synthesized. In yet another example, the personalized content may be wrapped into an articulation of the virtual presenter programmed to speak to the user.

In some embodiments, the audio data may also incorporate real-time driving context into the conservation with the user. For example, assume that the personalized content may include a song recommended to the user. The audio data may be created to include the following introduction speech from the virtual presenter: “Well, there is a traffic jam here. I'll keep you posted about the latest traffic info. Meanwhile, let's be relaxed and listen to this new song from artist A.” The introduction speech from the virtual presenter incorporates the real-time traffic condition. The audio data may also include an audio track of the recommended song, where the audio track follows the introduction speech in the audio data.

At block 208, the method 200 may include providing the audio data configured to be presented in the vehicle 111. For example, the audio data may be streamed to the vehicle 111 from the content server 101 and/or the third-party content provider 129 so that the audio data may be played in the vehicle 111 using the audio reproduction system 117. Alternatively, the audio data may be generated in the vehicle 111 and presented in the vehicle 111.

Additionally, the method 200 may include determining a driving context associated with the vehicle 111. The driving context may include a real-time driving context associated with a current journey taken by the vehicle 111.

In some embodiments, the personalized content and the audio data may be created by a third party such as the third-party content provider 129. The third party may configure what types of content to be presented to the user and which virtual presenter personality may be programmed to present the content.

In some embodiments, the personalized content may be generated proactively. The personalized content may be presented in an audio format by incorporating the personalized content into the audio data. More generally, the personalized content may also be presented in other formats such as a visual format.

In some embodiments, the personalized content may be formatted to appear as content in an interactive radio program in which a virtual radio DJ talks to a listener (e.g., the user in the vehicle 111). For example, the virtual radio DJ may provide commentary, respond to user comments, offer suggestions, and/or provide driving directions for the listener in real time or near real time. The personalized content may be created on-the-fly to match the user preference, the driving destination, and/or other driving context data.

In some embodiments, the personalized content may be referred to as interactive content. The user may interact with the personalized content by providing a user input. For example, after listening to a speech delivered by the virtual presenter, the user may press a steering wheel button (or a button on a panel or infotainment system) and/or may provide a verbal input to respond to the personalized content. In some embodiments, the user may provide a user input to add the personalized content to a to-do-list, to save the personalized content, to email the personalized content to the user's email box and/or to act upon the personalized content in some other way. For example, the user may provide a verbal input “add this song to my playlist” while listening to a song. Responsive to the user's verbal input, the method 200 may automatically add the song to the user's playlist.

The method 200 may include updating one or more of the personalized content and the virtual presenter personality based on the user input. The method 200 may also include updating the audio data based on updates in the personalized content and/or the virtual presenter personality. For example, the user may provide a verbal input that describes “tell me more about this news” after listening to the audio data related to a piece of news. After receiving and analyzing the user's verbal input, the method 200 may update the personalized content to include more news related to the same topic and may generate new audio data that covers the updated personalized content. The new audio data may be presented using the audio reproduction system 117 in the vehicle 111.

In a further example, assume that the audio data includes a promotion ad for a coffee shop that is located 4 blocks away from the user's current location. The user may respond with a verbal speech “I want to get a cup of coffee from the coffee shop” after listening to the promotion ad. The method 200 may include receiving and analyzing the user's verbal response. The method 200 may provide driving directions to the coffee shop responsive to the user's verbal response. The method 200 may also include sending a message to a computing device associated with the coffee shop to order a cup of coffee for the user. The method 200 may also include providing the user's pre-stored payment information to the computing device upon approval of the user so that the cup of coffee may be paid for automatically using the user's payment information. The method 200 may include synthesizing a speech configured to be delivered by the virtual presenter in which the virtual presenter may confirm the transaction with the user. The user may drive through a drive-through lane of the coffee shop to get the cup of coffee. However, there is no need for the user to hand over a credit card or cash to pay for the cup of coffee in person if the user has already paid as described above.

In yet another example, assume that the audio data includes an ad for a gift from an online store. The user may respond with a verbal speech “I want to get the gift from the store” after listening to the ad. The method 200 may include receiving and analyzing the user's verbal response and sending a transaction signal to a computing device associated with the online store to place an order for the gift. The method 200 may also include providing the user's pre-stored payment information to the computing device upon approval of the user so that the gift may be paid for automatically using the user's payment information. The method 200 may also include sending a pre-stored mailing address of the user to the computing device so that the online store may mail the purchased gift to the user's mailing address.

In some embodiments, multiple virtual presenter personalities may be determined so that the personalized content may be presented as a conversation between multiple virtual presenters. Each of the virtual presenters may speak in a manner that matches a corresponding virtual presenter personality. For example, the personalized content may include a recommendation of a point of interest (e.g., a monument) along a user Jane's driving route. The personalized content may be presented to Jane in an audio form by the following conversation:
Virtual Presenter “Anne”: Jane, since this is your first time to the city, you may want to check out a monument that is 10 blocks on your right. Let me introduce our city guide Wilson. Wilson knows everything about the city. Hi Wilson, can you give Jane a short introduction about the monument?
Virtual Presenter “Wilson”: Sure. Well, the monument was established in 1790 after the independence war . . . Jane, would you like to visit the monument now?
   If the user Jane is interested in the monument, she may respond with a verbal confirmation such as “Yes,” or “Yes, I would like to see the monument,” or any other similar response. One or more actions may be performed responsive to Jane's verbal confirmation. For example, the monument may be set as a destination for the user Jane and driving directions to the monument may be presented to the user as follows:
Virtual Presenter “Wilson”: Great! You will definitely enjoy it. Here are the driving directions to the monument.

In some embodiments, the method 200 may additionally include providing content alerts to the user. For example, the user may like a show and may have missed an episode of the show. The method 200 may include determining a virtual presenter configured to articulate an alert of the missed episode of the show to the user. The virtual presenter may be programmed to deliver the alert of the missed episode to the user proactively.

One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

Some embodiments disclosed herein include an article of manufacture such as a non-transitory computer storage medium having instructions stored thereon that are executable by a computing device to perform or control performance of operations included in the method 200 of FIG. 2, such as the operations illustrated by blocks 202, 204, 206, and/or 208 in FIG. 2, and/or variations thereof. The non-transitory computer storage medium may be included in or may be accessible to the content server 101, the third-party content provider 129, and/or the vehicle 111 of FIG. 1, such as the storage medium 105 or the storage medium 121. The computing device may include a processor or other processing device of the content server 101, the vehicle 111 or the third-party content provider 129, such as the processor 103 or the processor 113.

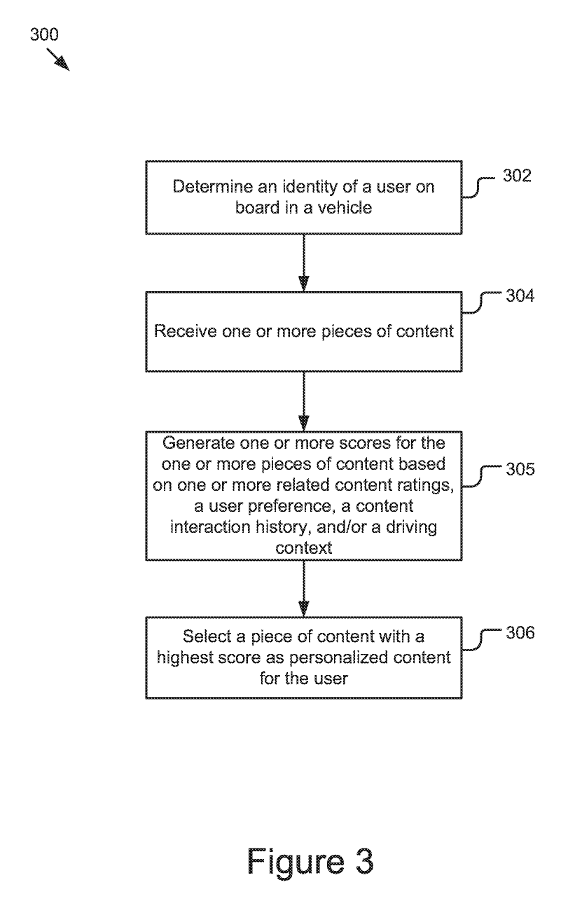

FIG. 3 shows an example flow diagram of a method 300 of personalizing content for a user, arranged in accordance with at least some embodiments described herein. The method 300 may be performed in whole or in part by, e.g., the content server 101, the third-party content provider 129, and/or the vehicle 111 of FIG. 1. Although illustrated as discrete blocks, various blocks may be divided into additional blocks, combined into fewer blocks, or eliminated, depending on the desired implementation.

The method 300 may begin at block 302 in which an identity of a user on board in the vehicle 111 may be determined. The user may be a driver or a passenger on board in the vehicle 111. User data such as a user profile, a user preference, a content interaction history of the user, and any other data related to the user may be accessed from the storage medium 105 and/or the storage medium 121 using the identity of the user.

At block 304, one or more pieces of content may be received. For example, the one or more pieces of content may be received from the content server 101, the third-party content provider 129, and/or any other content sources. The one or more pieces of content may include music, advertisements, news, podcasts, audio books, and any other suitable content.

At block 305, one or more scores may be generated for the one or more pieces of content, respectively. Each score associated with a corresponding piece of content may be generated based on a content rating related to the piece of content, the user preference, the content interaction history, a driving context, and/or any other customization factors. For example, the driving context may indicate that the user currently drives to a destination along a travel route. A first piece of content may describe a traffic accident along the travel route. A second piece of content may describe restaurant deals in the city. A first score generated for the first piece of content may be higher than a second score generated for the second piece of content since the traffic accident in the first piece of content may have an impact on the user's current driving task.

In another example, a first piece of content may include an album performed by an artist from a first media source. A second piece of content may include a story of the artist from a second media source. If the content interaction history indicates that the user has interacted with content from the first media source more frequently than content from the second media source, a higher score may be generated for the first piece of content than that of the second piece of content.

At block 306, a piece of content with a highest score may be selected from the one or more pieces of content as personalized content for the user.

Some embodiments disclosed herein include an article of manufacture such as a non-transitory computer storage medium having instructions stored thereon that are executable by a computing device to perform operations included in the method 300 of FIG. 3, such as the operations illustrated by blocks 302, 304, 305, and/or 306 in FIG. 3, and/or variations thereof. The non-transitory computer storage medium may be included in or may be accessible to the content server 101, the third-party content provider 129, and/or the vehicle 111 of FIG. 1, such as the storage medium 105 or the storage medium 121. The computing device may include a processor or other processing device of the content server 101, the vehicle 111 or the third-party content provider 129, such as the processor 103 or the processor 113.

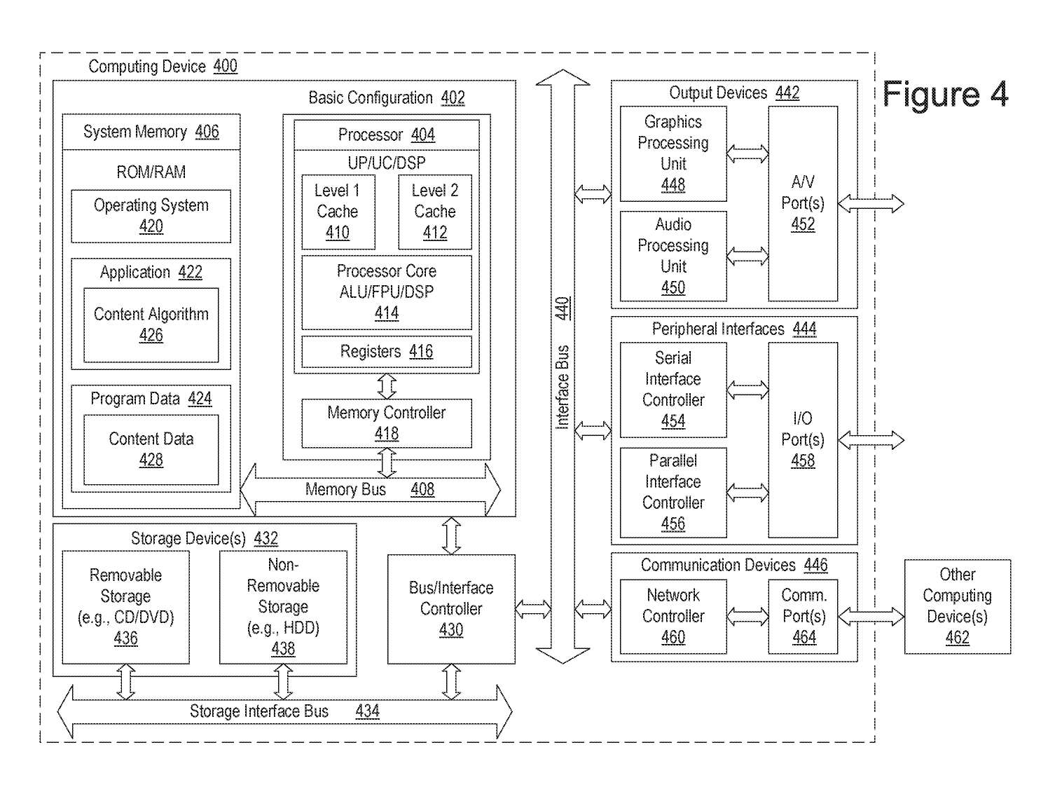

FIG. 4 is a block diagram that illustrates an example computing device 400 that is arranged for customizing and/or presenting content in a vehicle, in accordance with at least some embodiments described herein. The computing device 400 may be included in or correspond to any of the content server 101, the third-party content provider 129, and/or the vehicle 111 of FIG. 1, for example. In a very basic configuration 402, the computing device 400 may typically include one or more processors 404 and a system memory 406. A memory bus 408 may be used for communicating between the processor 404 and the system memory 406.

Depending on the desired configuration, the processor 404 may be of any type including, but not limited to, a CPU, a μP, a μC, a DSP, or any combination thereof. The processor 404 may include one or more levels of caching, such as a level one cache 410 and a level two cache 412, a processor core 414, and registers 416. The example processor core 414 may include an arithmetic logic unit (ALU), a floating point unit (FPU), a digital signal processing core (DSP core), or any combination thereof. An example memory controller 418 may also be used with the processor 404, or in some implementations the memory controller 418 may be an internal part of the processor 404.

Depending on the desired configuration, the system memory 406 may be of any type including, but not limited to, volatile memory (such as RAM), non-volatile memory (such as ROM, flash memory), or any combination thereof. The system memory 406 may include an operating system (OS) 420, one or more applications 422, and program data 424. The application 422 may include a content algorithm 426, an app, an application server, or other application that may be arranged to perform one or more of the functions as described herein including those described with respect to the methods 200 and/or 300 of FIGS. 2-3. The program data 424 may include content data 528 that may be pulled into the application 422 for analysis on one of the content server 101, the vehicle 111, and the third-party content provider 129 of FIG. 1, for example. In some embodiments, the application 422 may be arranged to operate with the program data 424 on the OS 420 such that implementations of methods for providing content configured to be presented in a vehicle and/or customizing the content, such as the methods 200 and 300 of FIGS. 2-3, may be provided as described herein.

The computing device 400 may have additional features or functionality, and additional interfaces to facilitate communications between the basic configuration 402 and any required devices and interfaces. For example, a bus/interface controller 430 may be used to facilitate communications between the basic configuration 402 and one or more data storage devices 432 via a storage interface bus 434. The data storage devices 432 may be removable storage devices 436, non-removable storage devices 438, or a combination thereof. Examples of removable storage and non-removable storage devices include magnetic disk devices such as flexible disk drives and hard-disk drives (HDD), optical disk drives such as compact disk (CD) drives or digital versatile disk (DVD) drives, solid state drives (SSD), and tape drives to name a few. Example computer storage media may include volatile and nonvolatile, removable and non-removable media implemented in any method or technology for storage of information, such as computer-readable instructions, data structures, program modules, or other data.

The system memory 406, removable storage devices 436, and non-removable storage devices 438 are examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by the computing device 400. Any such computer storage media may be part of the computing device 400.

The computing device 400 may also include an interface bus 440 for facilitating communication from various interface devices (e.g., output devices 442, peripheral interfaces 444, and communication devices 446) to the basic configuration 402 via the bus/interface controller 430. Example output devices 442 include a graphics processing unit 448 and an audio processing unit 450, which may be configured to communicate to various external devices such as a display or speakers via one or more A/V ports 452. Example peripheral interfaces 444 include a serial interface controller 454 or a parallel interface controller 456, which may be configured to communicate with external devices such as input devices (e.g., keyboard, mouse, pen, voice input device, touch input device) or other peripheral devices (e.g., printer, scanner) via one or more I/O ports 458. The example communication device 446 may include a network controller 460, which may be arranged to facilitate communications with one or more other computing devices 462 over a network communication link via one or more communication ports 464.

The network communication link may be one example of a communication media. Communication media may typically be embodied by computer-readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR), and other wireless media. The term computer-readable media as used herein may include both storage media and communication media.

The computing device 400 may be implemented as a portion of a small-form factor portable (or mobile) electronic device such as a cell phone, a personal data assistant (PDA), a personal media player device, a wireless web-watch device, a personal headset device, an application-specific device, or a hybrid device that includes any of the above functions. The computing device 400 may also be implemented as a personal computer including both laptop computer and non-laptop computer configurations.

The present disclosure is not to be limited in terms of the particular embodiments described herein, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that the present disclosure is not limited to particular methods, reagents, compounds, compositions, or biological systems, which can, of course, vary. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method of providing content for presentation in a vehicle, the method comprising:
creating personalized content for a user based on one or more customization factors;
determining a virtual presenter personality configured to customize a presentation of the personalized content;
creating audio data that incorporates the personalized content based on the virtual presenter personality; and
providing the audio data configured to be presented in the vehicle.

2. The method of claim 1, wherein the one or more customization factors include one or more of a user preference, a user profile, a content interaction history, and a driving context.

3. The method of claim 1, further comprising determining a driving context associated with the vehicle.

4. The method of claim 3, wherein the audio data is created to incorporate the driving context and is formatted as a conversation with the user.

5. The method of claim 3, wherein the driving context includes one or more of a journey destination, a route, a time of day, a weather condition, a traffic condition, and a driving scene along the route.

6. The method of claim 1, wherein the virtual presenter personality is determined based on one or more of a content type of the personalized content, a driving context, a user preference, and a default setting.

7. The method of claim 1, further comprising:
receiving a user input; and
updating one or more of the personalized content and the virtual presenter personality based on the user input.

8. A non-transitory computer storage medium having computer instructions stored thereon that are executable by a computing device to perform operations comprising:
creating personalized content for a user based on one or more customization factors;
determining a virtual presenter personality configured to customize a presentation of the personalized content;
creating audio data that incorporates the personalized content based on the virtual presenter personality; and
providing the audio data configured to be presented in the vehicle.

9. The non-transitory computer storage medium of claim 8, wherein the one or more customization factors include one or more of a user preference, a user profile, a content interaction history, and a driving context.

10. The non-transitory computer storage medium of claim 8, wherein the operations further comprise determining a driving context associated with the vehicle.

11. The non-transitory computer storage medium of claim 10, wherein the audio data is created to incorporate the driving context and is formatted as a conversation with the user.

12. The non-transitory computer storage medium of claim 10, wherein the driving context includes one or more of a journey destination, a route, a time of day, a weather condition, a traffic condition, and a driving scene along the route.

13. The non-transitory computer storage medium of claim 8, wherein the virtual presenter personality is determined based on one or more of a content type of the personalized content, a driving context, a user preference, and a default setting.

14. The non-transitory computer storage medium of claim 8, wherein the operations further comprise:
receiving a user input; and
updating one or more of the personalized content and the virtual presenter personality based on the user input.

15. A system of providing content for presentation in a vehicle, the system comprising:
a processor; and
a non-transitory computer storage medium having computer instructions stored thereon that are executable by the processor to perform operations comprising:
creating personalized content for a user based on one or more customization factors;
determining a virtual presenter personality configured to customize a presentation of the personalized content;
creating audio data that incorporates the personalized content based on the virtual presenter personality; and
providing the audio data configured to be presented in the vehicle.

16. The system of claim 15, wherein the one or more customization factors include one or more of a user preference, a user profile, a content interaction history, and a driving context.

17. The system of claim 15, wherein the operations further comprise determining a driving context associated with the vehicle.

18. The system of claim 17, wherein the audio data is created to incorporate the driving context and is formatted as a conversation with the user.

19. The system of claim 17, wherein the driving context includes one or more of a journey destination, a route, a time of day, a weather condition, a traffic condition, and a driving scene along the route.

20. The system of claim 15, wherein the virtual presenter personality is determined based on one or more of a content type of the personalized content, a driving context, a user preference, and a default setting.
